(19) United States
(12) Patent Application Publication
(10) Pub. No.: US 2007/0233678 A1
(43) Pub. Date: Oct. 4, 2007

(54) SYSTEM AND METHOD FOR A VISUAL CATALOG

(76) Inventor: David H. Bigelow, Greenwood, IN (US)

Correspondence Address: BOSE MCKINNEY & EVANS LLP;JAMES COLES, 135 N PENNSYLVANIA ST, SUITE 2700, INDIANAPOLIS, IN, 46204, US

(21) Appl. No.: 11/696,334

(22) Filed: Apr. 4, 2007

Related U.S. Application Data
(60) Provisional application No. 60/789,189, filed on Apr. 4, 2006.

(51) Int. Cl. G06F 17/30

(52) U.S. Cl. 707/6

(57) ABSTRACT

A virtual catalog system and method for collecting, classifying, storing and exploiting a plurality of assets. The system uses a keyword tree comprising a plurality of nodes that each include at least one keyword. Assets are classified by associating a keyword set with each classified asset, the keyword set including one or more keywords. Searches of the assets are done based on search requests of one or more keywords. The search results are displayed in a results tree having a branch for each keyword or keyword group included in the search request, and a results set is displayed wherein each asset of the results set is associated with all of the keywords included in the search request.

This application claims the benefit of U.S. Provisional Application Ser. No.

60/789,189, filed on Apr. 4, 2006, entitled “System and Method for a Visual Catalog,” which is incorporated herein by reference

### BACKGROUND OF THE INVENTION

### Background and Summary of the Invention

The present invention relates generally to the fields of image asset management and storage, and more specifically to the acquisition and organization of image assets for retrieval, publication or other exploitation by one or more users.

With the ready availability of displays and the greater impact of images as opposed to words, communication is becoming more and more visual. Visual communication is being used more and more for business, educational, social and other purposes. As a result numerous images have been created and have been made easily available for people to use in visual communications. However, the vast numbers of images have made it a challenging and time consuming endeavor to put together a visual communication with appropriate images.

A visual catalog system enables a user to collect, store, organize, share and manage visual content using keywords standard to the catalog system. The user can then retrieve the desired visual content or image assets using the standard keywords. The user can also select an image asset that is close to what he is looking for and then use the catalog system to find similar image assets. The visual content can be used to create visual layouts in the catalog system. The visual content can also be exported to other applications, published or exploited in various other ways.

Additional features and advantages of the invention will become apparent to those skilled in the art upon consideration of the following detailed description of illustrated embodiments.

### BRIEF DESCRIPTION OF THE FIGURES

Aspects of the present invention are more particularly described below with reference to the following figures, which illustrate exemplary embodiments of the present invention

FIG. 1 is a diagram of the some of the routines in a visual catalog system and this description;

FIG. 2 is an example of a login and password window;

FIG. 3 is diagram of an overview of the visual catalog system;

FIG. 4 is a diagram of an embodiment of an administration interface of a visual catalog system;

FIG. 5 is a diagram of an embodiment of a user interface of a visual catalog system;

FIG. 6 is a diagram of a search engine process of a visual catalog system;

FIG. 7 is a diagram of a tree based keyword taxonomy available in an administration interface of a visual catalog system;

FIG. 8 shows an embodiment of a user interface screen for a visual catalog system;

FIG. 9 shows an embodiment of a “Find Similar” function in a user interface for a visual catalog system;

FIG. 10 is a diagram of an embodiment of a results tree displayed in a users interface for a visual catalog system;

FIG. 11 shows an embodiment of an administration interface screen for a visual catalog system.

FIG. 12 shows an alternative embodiment of a user interface screen for a visual catalog system;

FIG. 13 shows an embodiment of a popup menu/toolbar in a user interface screen for a visual catalog system;

FIG. 14 shows an alternative embodiment of a “Find Similar” function in a user interface for a visual catalog system;

FIG. 15 shows an embodiment of a layout interface for preparing content of a visual catalog system;

FIG. 16 shows an embodiment for exporting content from a visual catalog system to another application; and

FIG. 17 shows an alternative embodiment for exporting content from a visual catalog system to another application.

### DETAILED DESCRIPTION OF EXEMPLARY EMBODIMENTS OF THE INVENTION

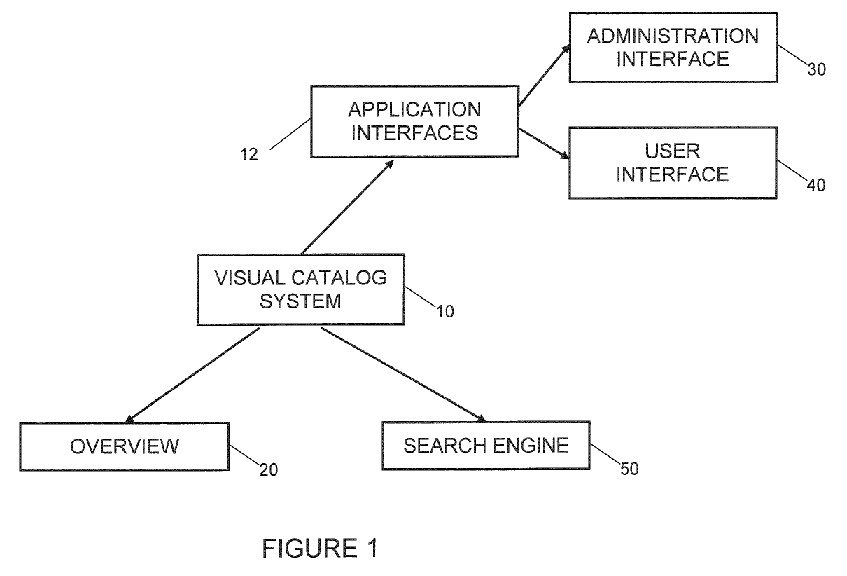

FIG. 1 shows a top-level schematic diagram of the visual catalog system 10 of the present invention. The visual catalog system 10 is a software system that runs on a computer system and preferably runs over a network, allowing users and administrators located remotely from one another to interface through the networked computer system. The visual catalog system 10 comprises application interfaces 12 and a search engine 50. The application interfaces 12 include an administration interface 30 and a user interface 40. An overview 20 is also shown in FIG. 1 which is used to describe some of the implementation options, capabilities and uses of the visual catalog system 10.

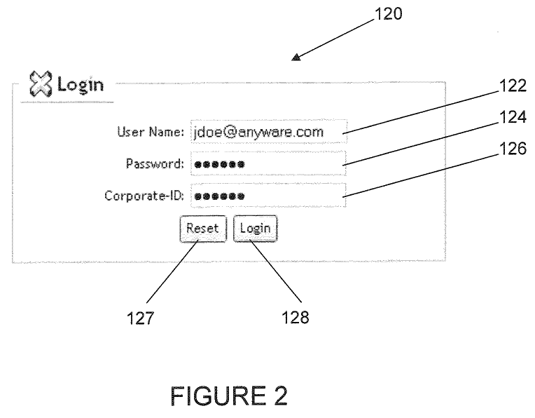

The visual catalog system 10 can have a user specific login and password window to identify an individual user and determine the rights of the user. An example login and password window 120 is shown in FIG. 2. The window 120 includes a username field 122, a password field 124 a corporate ID field 126, a reset button 127 and a login button 128. The user identifies herself by entering her specific identification information in the username field 122, password field 124 and corporate ID field 126. The corporate ID field 126 can be used to distinguish users based on their company, division within a company or other information that can be used to designate the access privileges for the user session on the visual catalog system 10. When the user has entered the appropriate information in the username field 122, password field 124 and corporate ID field 126, the login button 128 is activated. If the user information is recognized, the user is granted access to the visual catalog system 10. The reset button 127 can be activated to clear the username field 122, password field 124 and corporate ID field 126 of the window 120.

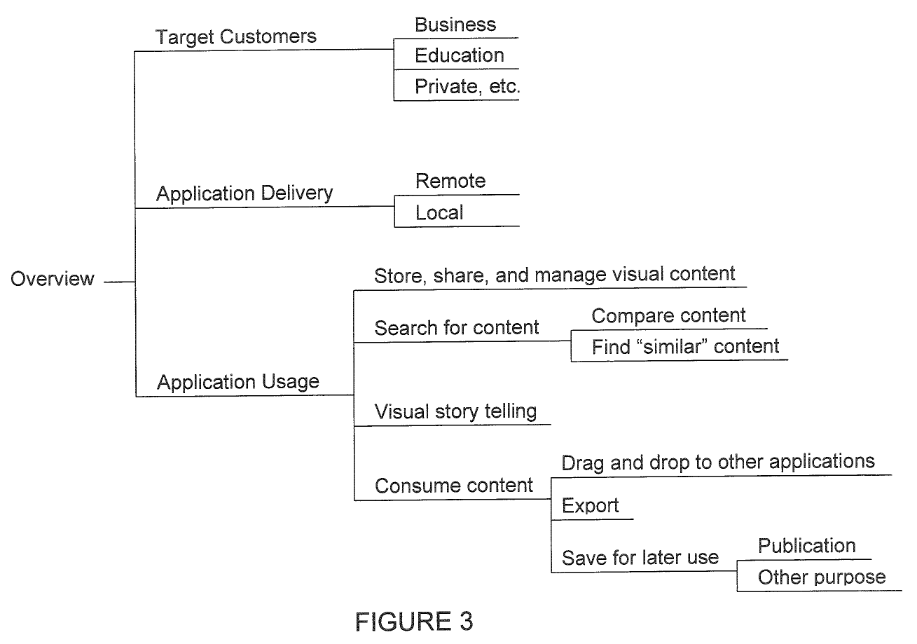

A schematic diagram of an overview 20 of the visual catalog system 10 is shown in FIG. 3. As will become more clear as the visual catalog system 10 is described, the visual catalog system 10 will be useful for business, educational, private and many other purposes. The visual catalog system 10 can be run remotely or locally. A remote embodiment could include running the visual catalog system 10 as a network application through a browser-interface on a local computer, with the software installed on a remote system. The local computer can be networked to the remote system through various methods known in the art, such as through a local area network (LAN), wide-area network (WAN), the Internet, etc. A local embodiment could include running the visual catalog system 10 as a local application installed on the user's or administrator's local computer.

The visual catalog system 10 enables a user to search for visual content, and to store, classify, share and manage visual content. These capabilities include the ability to compare content and to find similar content. The capability to store, share and manage visual content, and the capability to search for content will be described in more detail in the discussion of the application interfaces 12 and the search engine 50.

The visual catalog system 10 also enables a user to consume the content in various ways. Once the user obtains the content through the visual catalog system 10, the user can use the content for various purposes. One way the user can use the content is for visual story telling by creating a visual story board within and/or using the content found through the visual catalog system 10. The visual story board can be used to combine and arrange content found within the visual catalog to mockup, share, collaborate on and publish a desired visual story. The user can also consume content in many other ways, including dragging and dropping the visual content into other applications, exporting the content remotely or saving the content locally for later use.

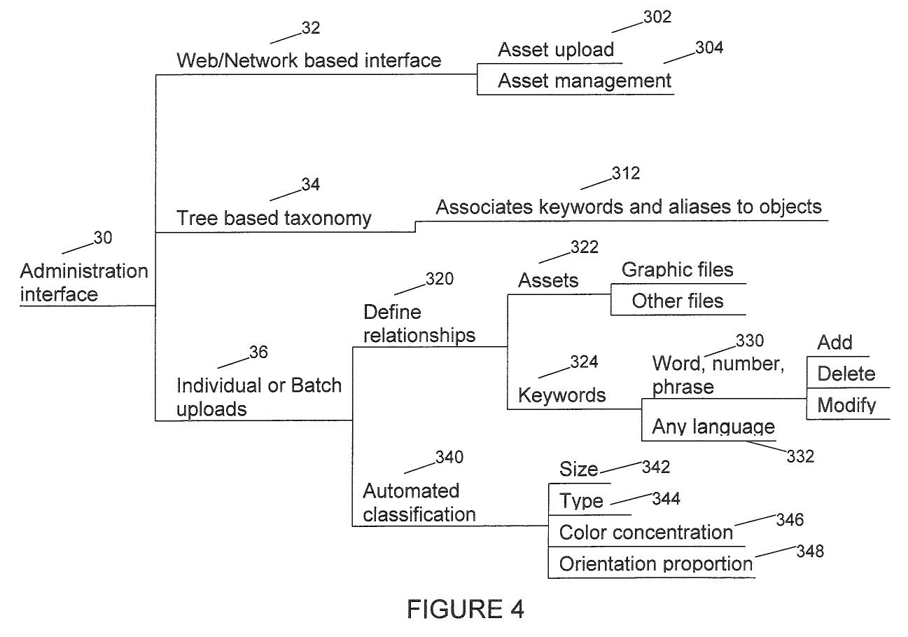

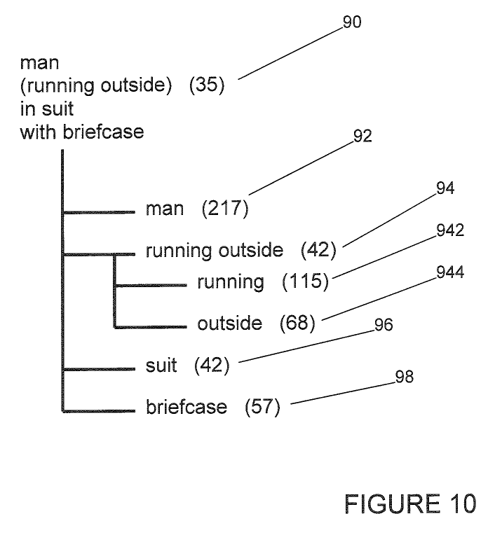

FIG. 4 provides a schematic overview of the functionality of the administration interface 30, and FIG. 10 shows one possible embodiment of the administration interface 30. The administration interface 30 can be a web/network based interface 32 or a local interface that enables asset upload 302 and asset management 304. The asset upload 302 enables the administrator to upload and store content in the visual catalog system 10. After the content is uploaded into the visual catalog system 10, the asset management feature 304 enables the classification of the content for later retrieval.

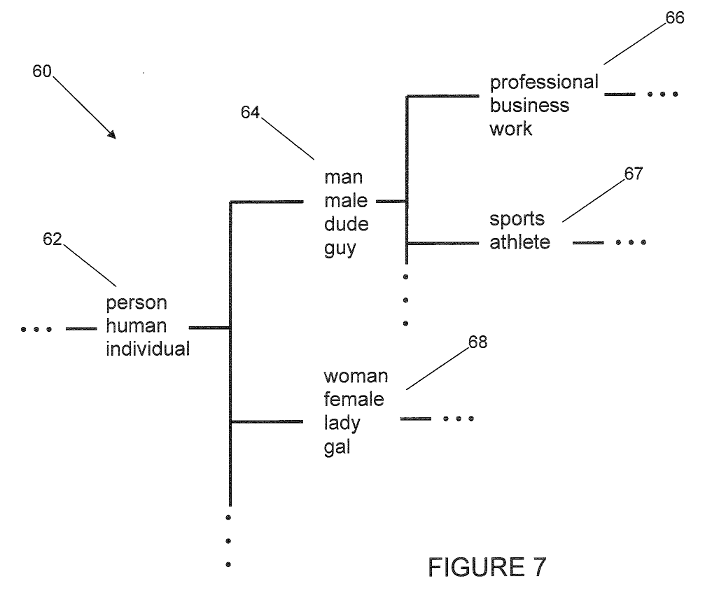

The administration interface 30 can include a tree based taxonomy 34 to make the classification of an uploaded asset faster and more efficient for the administrator. The tree based taxonomy 34 is used to associate keywords and aliases with an input asset 312. The tree based taxonomy 34 includes a tree structure of keywords for selection by the administrator. One example of a tree based taxonomy 34 according to the present invention is shown in FIG. 7, which shows a portion of a keywords tree 60 with five nodes 62, 64, 66, 67 and 68 of a much larger classification tree 60. The node 62 is closest to the root of the tree, and is a parent node connected by branches to child nodes 64 and 68. The node 64 is a child of node 62, and node 64 is also a parent node connected to child nodes 66 and 67 which are further out on the branches of the classification tree 60. A child node represents a more specific classification within the more general classification of its parent node. The node 62 includes keywords “person,” “human” and “individual.” The node 64 is a child of node 62 and includes masculine sub-classification keywords “man,” “male,” “dude,” and “guy.” The node 68 is also a child of node 62 and includes feminine sub-classification keywords “woman,” “female,” “lady,” and “gal.”

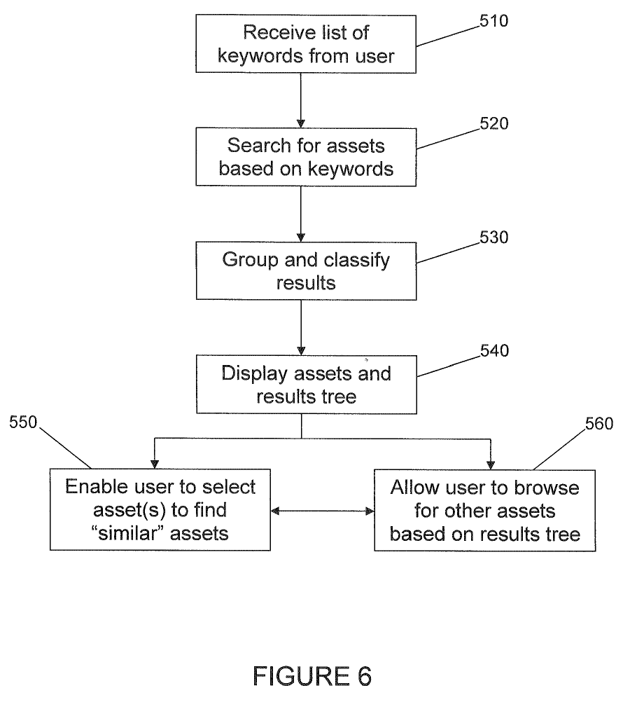

When the administrator is classifying an input asset that includes a male athlete, the administrator can simply select node 67 and the keywords associated with node 67 as well as the more general keywords associated with its parent node 64 and any ancestor nodes on the branch extending up to the root of the tree, including node 62, are associated with the input asset. Thus, in the case of the tree in FIG. 6, the selection of node 67 associates the keywords “sports,” “athlete,” “man,” “male,” “dude,” “guy,” “person,” “human” and “individual” with the asset, as well as any keywords on any other ancestor nodes along the branch up to the root of the tree 60. The administrator can select additional nodes in the same or different trees to associate further keywords with the input asset. The use of the tree based taxonomy 34 provides consistency in keywords and also helps insure that any aliases, synonyms or slang terms for a keyword are included in the classification of an input asset.

Assets can be added to the visual catalog 10 individually or in batch uploads 36. An asset in the visual catalog is often an image file, which can be standalone or include various image formats or other metadata, files and/or references to the asset/object. The visual catalog system 10 enables the administrator to define relationships 320 between the input asset 322 and keywords 324. The keywords 324 can be any word, number, phrase or other identifier 330, and can be in any language 332. One method for quickly associating keywords with assets is using the tree based taxonomy 34 described above. Instead of, or after, associating keywords with assets using the tree based taxonomy 34, the administrator can further customize the keywords associated with the asset by adding additional keywords, or by deleting or modifying keywords previously associated with the asset.

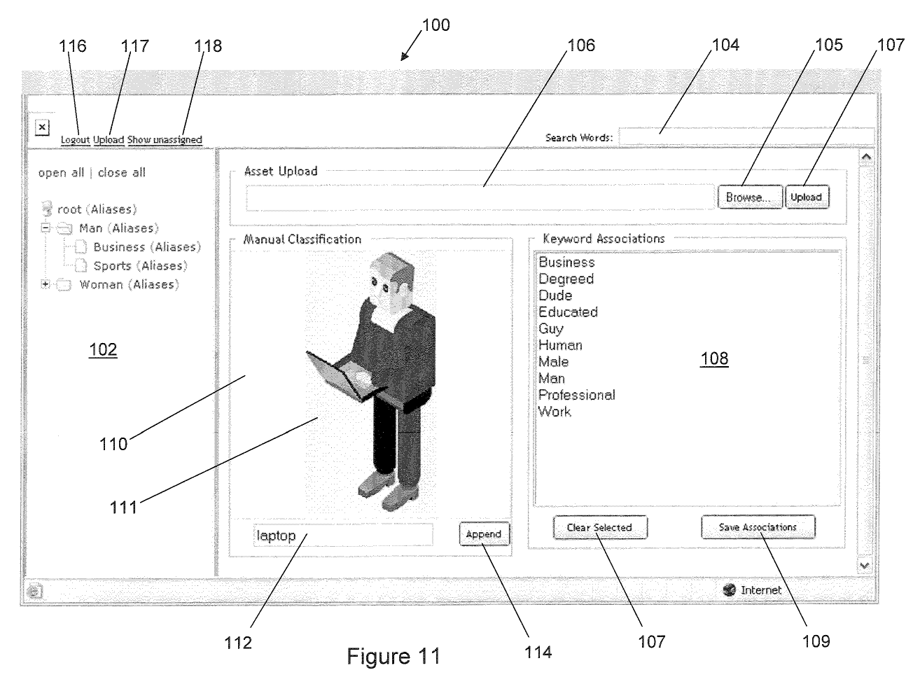

The embodiment of the administration interface 100 shown in FIG. 11 provides one example of an administration interface 30 for the visual catalog system 10. The administration interface 100 includes a search field 104, a classification tree section 102, an asset upload section 106, a keyword associations section 108, and a manual classification section 110. The administrator can enter search terms in the search words field 104 to obtain a list of potential assets fitting a desired search criteria that are stored locally or remotely. In the asset upload section 106, the user enters the filename for an asset or uses the browse button 105 to display a list of filenames and selects the desired file(s). The asset contained in the file displayed in the asset upload section 106 is uploaded by selecting the upload button 107. The uploaded asset is then displayed in a display portion 111 of the manual classification section 110. The administrator can then navigate through the classification tree 60 displayed in the classification tree section 102. Note that the classification tree shown in the classification tree section 102 is a portion of the classification tree 60 shown in FIG. 7, and that a single keyword is displayed in the classification tree section 102 for each node. By simply selecting the business node 66 shown in the classification tree 60, eight of the keywords shown in the keyword associations section 108 are associated with the uploaded asset, namely “business,” “professional,” “work,” “man,” “male,” “dude,” “guy,” “person,” and “human.” The keyword “individual” would also be associated with the uploaded asset when the business node 66 is selected, but could be deleted from the keyword associations as explained below.

A keyword can be deleted from the keyword associations for an asset by selecting the keyword to be deleted in the keyword associations section 108 and selecting the “Clear Selected” button 107. Additional keywords can be added to the keyword associations for an asset by entering the new keyword in keyword entry field 112 in the manual classification section 110 and selecting the “Append” button 114. When all of the desired keywords for classifying the asset 111 are displayed in the keyword associations section 108, the associations are saved by selecting the “Save Associations” button 109 in the keyword associations section 108.

The keywords listed in the keyword associations section 108 can be ordered by level of importance or relevance to the asset 111. For example, the keywords can be separated into primary, secondary and tertiary levels. This can then be exploited in searching for assets of interest. If the asset 111 is a man holding a laptop and wearing black shoes, then the keywords for “man” may be primary, the keywords for “laptop” may be secondary, and the keywords for “black shoes” may be tertiary since they form a small part of the asset. In contrast, an asset that is just a picture of a pair of black shoes will have the keywords for “black shoes” as primary. Then, when a user is searching for assets showing “black shoes,” the picture of black shoes will show up as higher relevance than the asset 111 showing a man holding a laptop and wearing black shoes.

The embodiment of the administration interface 100 shown in FIG. 10 also includes a “Logout” link 116, an “Upload” link 117 and a “Show unassigned” link 118. The “Logout” link 116 can be used by the administrator to logout of the visual catalog system 10. The “Upload” link 117 can be used to gain access to local or remote sites to gather additional content for the visual catalog system 10. The “Show unassigned” link 118 can be used to bring up the content that has yet to be assigned keyword associations. For example, when a batch of unassigned files is uploaded to the system, they are initially not associated with any keywords. The administrator can then activate the unassigned link 118 to bring up the unassigned files. The administrator can then select the desired unassigned files and assign keywords to them using the features of the administration interface 100.

The visual catalog system 10 can include further automatic classification 340 to further classify an input asset. Some possible automatic asset classifications include asset size 342, asset type 344, color concentration 346 and asset orientation proportion 348. The asset size 342 can be automatically associated with the asset. The asset size 342 can be described in various ways, including: storage size (bits), original image size (square inches), number of pages, number of frames, etc. The asset type 344 can also be automatically associated with the asset. An example of a way to characterize asset type 344 is by file type, such as graphics interchange format (.gif), Joint Photographic Experts Group format (.jpg), portable network graphics format (.png), Adobe Acrobat format (.pdf), etc. The color concentration 346 of the asset can also be automatically associated with the asset. The color concentration 346 can be characterized in many ways including: bits per pixel, black and white, gray scale, color, percentage of pixels of a particular color, transparent background, solid background, etc. The asset orientation proportion 348 can also be automatically associated with the asset. The asset orientation proportion 348 can be characterized in many ways including: horizontal, vertical, portrait, landscape, some ratio of pixels in the horizontal and vertical directions, etc.

A thumbnail display of an asset in the visual catalog system can represent multiple versions of the asset. For example, if the asset is available to the system in graphics interchange format (.gif), and Adobe Acrobat format (.pdf), and also in two different resolutions for each format, then one thumbnail can be displayed in the display windows of the visual catalog system 10 to represent the four versions of the same asset. As will be described below, the user will have the ability to select attributes to find the desired version of the asset.

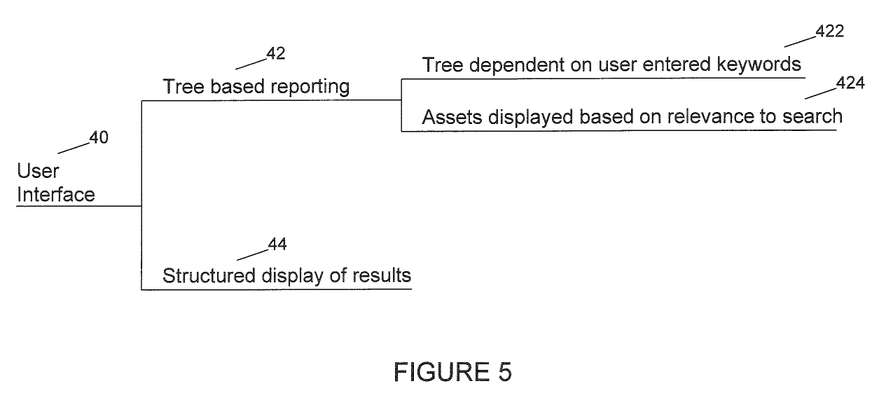

FIG. 5 provides a schematic overview of some of the functionality of the user interface 40. The user interface 40 provides tree based reporting of results 42 and a structured display of results 44. The results tree is dependent on the user entered keywords 422 and the assets are displayed based on relevance to the search terms 424. The user interface 40 can also include functionality to allow the user to view and customize asset keyword associations similar to those described above for the administration interface 30.

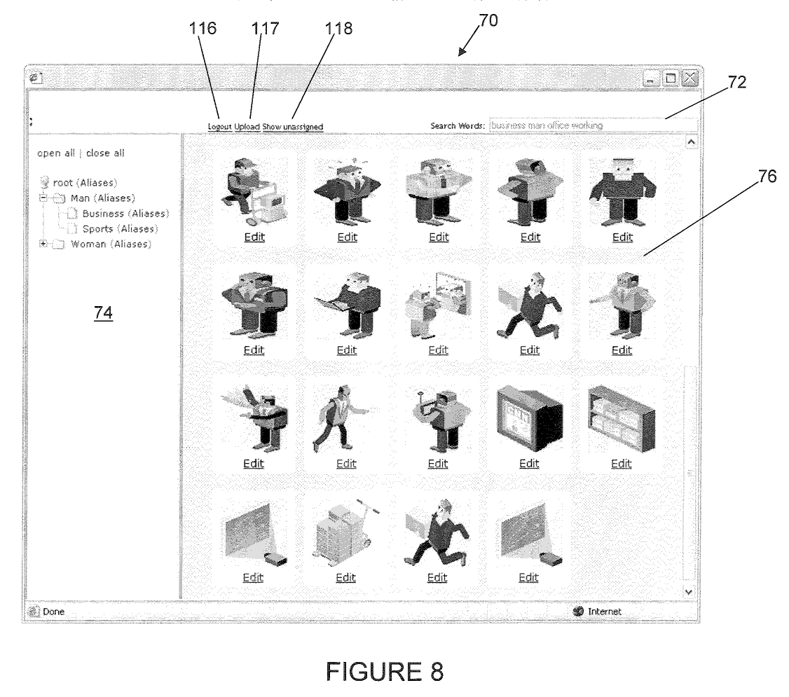

FIG. 8 shows one embodiment of a user interface 70 for the visual catalog system 10. The user enters search terms in a search field 72, or the user can leave the search filed 72 empty to browse all of the available assets. The assets found in the search are displayed in a results section 76, and a results tree 74 is shown of the search terms. The assets found in the search are ordered based on the relevance of the asset to the search terms. The ordering of the results can be done in various ways, some examples including primarily spatial ordering (for example, top-down, right left, upper-left to lower-right, center-outward, etc.), using a multi-dimensional graph or tree structure, or using colorization or some visual pattern to indicate higher to lower percentage matches (for example, solid green transitioning to white over a range of 100% match to 0% match).

The user interface 70 can also include functionality that makes the visual catalog system 10 more “forgiving” regarding user input. For example, the user interface 70 can first run a spell check on the search field 72 to correct any misspellings made by the user. The user interface 70 can also include a thesaurus to suggest or add additional terms for the search field 72. The thesaurus entries can be based on terms used in the asset classification system of the administrator. The user interface 70 can also include a sounds-like option to suggest or add additional terms for the search field 72, such as, for example, the Soundex phonetic algorithm for indexing names by their sound when pronounced in English. These “forgiving” features can automatically make changes to the search field 72, or display suggested recommendations for the user's selection. The user interface 70 can also include customizable options for each or all of these “forgiving” features to automatically apply recommendations, to display suggested recommendations for user selection, or to turn off the “forgiving” feature(s).

FIG. 10 shows another embodiment of a search results tree for the user interface 40. The search results tree in FIG. 10 is for the search request “man (running outside) in suit with briefcase” 90. The search has search terms of “man” 92, “suit” 96, “briefcase” 98 and “the two words “running” 942 and “outside” 944 grouped together as “running outside” 94. The connector terms “in” and “with” are not used in this search example. The number following the search request shows the number of assets found that satisfy all of the search terms in the search request, which in this case is 35. The search tree then shows the user how many hits were found for each of the terms in the search request. Thus, the search term “man” had 217 hits, the search term “running outside” had 42 hits, the search term “suit” had 42 hits and the search term “briefcase” had 57 hits. The search tree also shows that the hits for each search term in any grouping of search terms entered by the user. In the case shown in FIG. 10, the user grouped the terms “running” and “outside” together. There were 115 hits for the search term “running” and 68 hits for the search term “outside.” The user can select any node or nodes in the search tree shown in FIG. 10 and display the assets meeting the selected search criteria. For example, if the user selected the branch “running outside” 94 then the search results would show the 42 hits found for the search “running outside”.

FIG. 6 provides a schematic overview of the process of the search engine 50. In step 510, the search engine 50 receives a list of keywords from the user. In the user interface embodiment shown in FIG. 8, these are the keywords entered by the user in the search field 72.

In step 520, the search engine 50 searches for assets based on the keywords entered by the user. For the example of FIG. 10, the search engine finds the 217 assets having the keyword “man” associated with them, 115 assets having the keyword “running” associated with them, 68 assets having the keyword “outside” associated with them, 42 assets having the keyword “suit” associated with them, and 57 assets having the keyword “briefcase” associated with them.

In step 530, the search engine 50 groups and classifies the results. For the example of FIG. 10, the search engine groups the 115 assets having the keyword “running” associated with them, and the 68 assets having the keyword “outside” associated with them, and finds the intersection set of the 42 assets having both “running” and “outside” associated with them. Then, for the example of FIG. 10, the search engine groups the 217 assets having the keyword “man” associated with them, the 42 assets having the keyword “running outside” associated with them, the 42 assets having the keyword “suit” associated with them, and the 57 assets having the keyword “briefcase” associated with them, and finds the 35 assets with all of the keywords for the combined search term “man (running outside) in suit with briefcase.”

In step 540, the search engine 50 presents the assets and the results tree to the user. In the user interface embodiment shown in FIG. 8, the search engine 50 displays the assets found in the results section 76 and the search tree in the tree section 74 of the display 70.

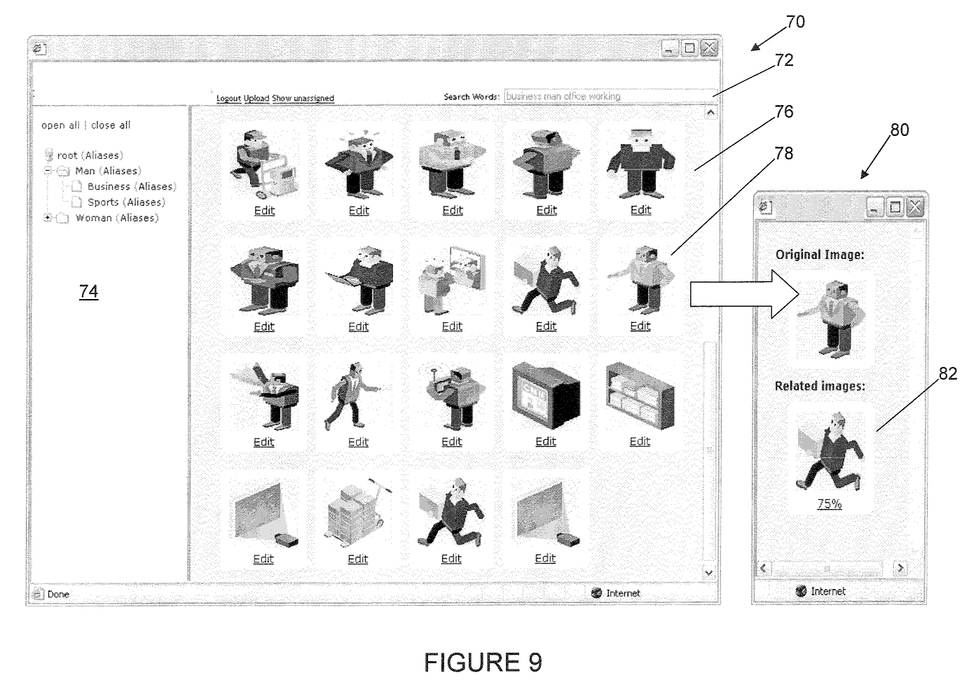

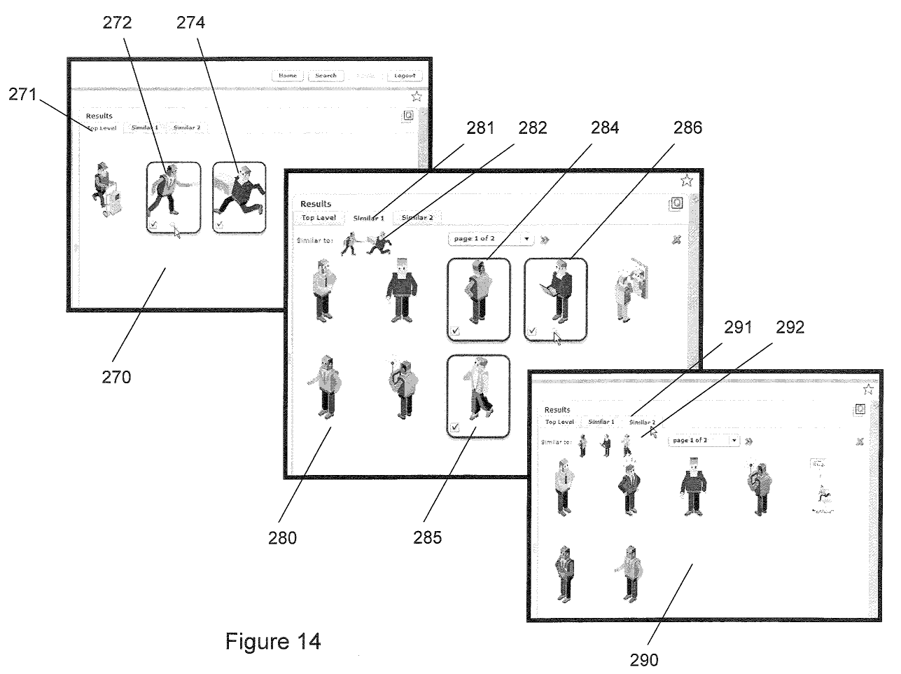

In step 550, the user can select one or more assets to find similar assets. FIGS. 9 and 14 show alternative embodiments of the find similar function. In FIG. 9, the user selects an asset 78 in the search results section 76 and chooses the function “Find Similar.” The “Find Similar” function, looks at the keywords associated with the selected asset 78 in the visual catalog system 10, and then finds assets with the highest number of the same keyword associations, and/or the priorities given to the keywords (for example, primary, secondary and tertiary, as discussed above). The “Find Similar” function, can then display the assets that were found based on their relevance to the selected asset 78 in the order from most keywords with the highest priorities to the least keywords with the lowest priorities. In the example shown in FIG. 9, the asset 82 was found with a relevance of 75%.

The user interface 40 can also include an interface to the search engine 50 that allows the user to compare assets by comparing the keywords and/or automatic associations associated with the assets. This can help the user to determine better keywords and associations for a desired search, and keywords or associations that can be eliminated for the desired search.

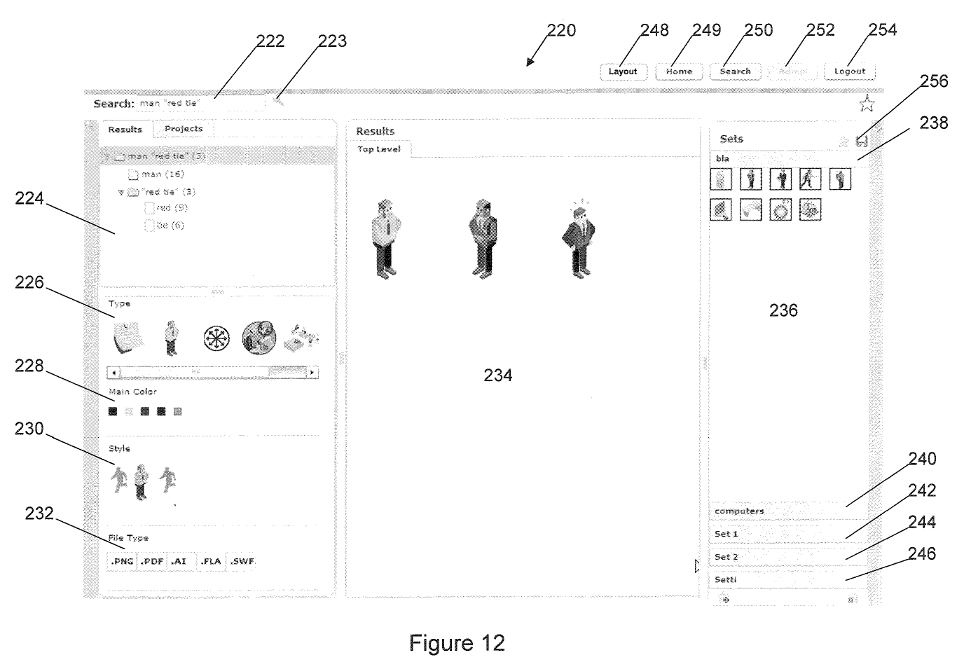

FIG. 12 shows an alternative embodiment 220 of the user interface 40. The embodiment 220 includes a search field 222, a search icon 223, a results section 234 and results attribute sections 226, 228, 230 and 232. The user can enter the desired keywords for the search in the search field 222 and then either select the search icon 223 or hit the “Enter” key on a keyboard associated with the display. The visual catalog system 10 searches for assets based on the keywords, groups and classifies the results, and displays the assets found in the results section 234 and in a results tree 224 for the search terms. In the example shown in FIG. 12, the search terms are “man (red tie)” as shown in the search term field 222. The visual catalog system 10 found, as shown in the results tree 224, 16 assets associated with the keyword “man,” 9 assets associated with the keyword “red,” and 6 assets associated with the keyword “tie.” Of the assets found, 3 are associated with both keywords “red” and “tie,” and 3 are associated with “man” and “red tie.” The three assets associated with “man (red tie)” are displayed in the results section 234.

The user can manually navigate the assets found in the search by selecting branches in the results tree 224. Currently, the “man (red tie)” branch of the tree shown in the results tree section 224 is selected, which displays the three assets meeting that search criteria to be displayed in the search results section 234. If the user were to select the “tie” branch of the tree shown in the results tree section 224 is selected, then the six assets meeting that search criteria would be displayed in the search results section 234.

The user interface embodiment 220 also displays a type attribute field 226, a main color attribute field 228, a style attribute field 230 and a file type attribute field 232. These fields can be used to find out attribute information about assets displayed in the search results section 234 or to filter the assets displayed in the search results section 234. If an asset displayed in the results section 234 is selected, then the associated values for the selected asset are displayed in the type attribute field 226, main color attribute field 228, style attribute field 230 and file type attribute field 232. Alternatively, a desired attribute set can be chosen by selecting one or more values in one or more of the type attribute field 226, main color attribute field 228, style attribute field 230 and file type attribute field 232, and only those assets having the desired attribute set are displayed in the search results section 234. One thumbnail in the search results section 234 can represent multiple versions of an asset, and therefore more than one attribute value may be displayed in an attribute field 226, 228, 230, 232.

The user interface embodiment 220 also enables the user to create image sets. In the example shown in FIG. 12, the user currently has access to five image sets with title bars labeled “bla” 238, “computers” 240, “Set 1” 242, “Set 2” 244 and “Setti” 246. The user has selected the “bla” set 256, and the assets contained in the “bla” set 238 are displayed in the image set section 236. The user can choose another set to be displayed in the image set section 236 by selecting another set title bar 240, 242, 244 or 246.

One or more assets in the search results section 234 can be added to one or more of the image sets. If the image set is currently displayed in the image set section 236, the asset(s) to be added can be selected in the search results section 234, then the selected asset(s) can be dragged and dropped into the image set section 236. If the image set is not currently displayed in the image set section 236, the asset(s) to be added can be selected in the search results section 234, then dragged to a position in which the cursor causes the title bar for the desired image set to be highlighted, and then the selected assets can be dropped into the image set with the highlighted title bar.

One or more of the image sets can be shared between multiple users. For example, if multiple users at the same location or at remote locations want to collaborate on putting together an image set, they can create a shared image set in which each user has the ability to add, delete and reorder images in the shared image set. Then when a change is made to the shared image set by one of the users, the image set display in the image set section 236 will be updated for all of the users viewing the shared image set.

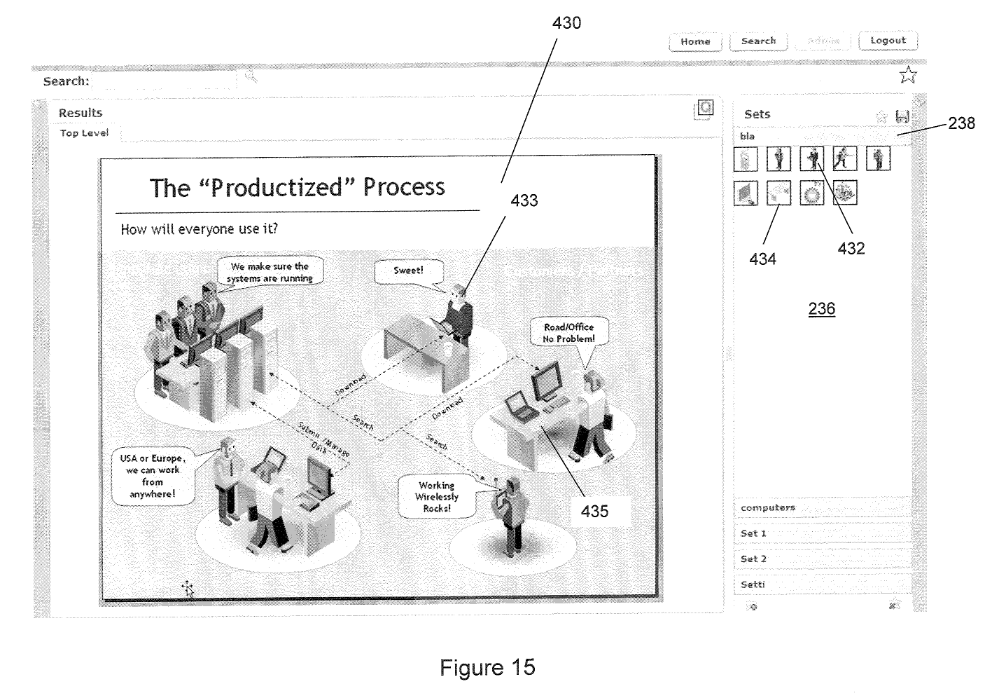

The user interface embodiment 220 also has navigation and control buttons which include a Layout button 248, a Home button 249, a Search button 250, an Admin button 252, a Logout button 254 and a Save icon 256. By selecting the Layout button 248, a layout screen is opened or the user is switched to a currently active layout screen. An example of a layout screen is shown in FIG. 15. By selecting the Home button 249, the user is redirected to a home/welcome page. By selecting the Search button 250, the user is switched to a user interface search screen 220. By selecting the Admin button 252, the user is redirected from the user level interface to the administration interface. In the example shown in FIG. 12, this button is grayed-out indicating the current user does not have administrator privileges. This button could alternatively not be shown when the user does not have administrator privileges. By selecting the Logout button 254, the user is logged out of the visual catalog system 10. By selecting the Save icon button 256, the user can save the image sets that were created during the sessions on the visual catalog system 10 or download the image sets locally.

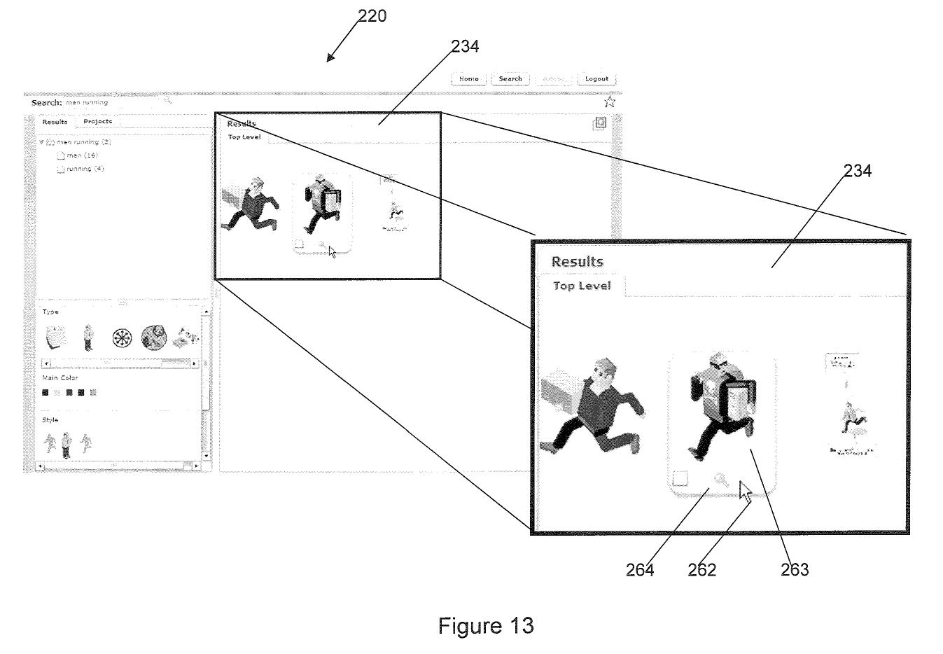

The user interface embodiment 220 can also have popup menus/toolbars for the displayed assets that are activated and displayed based on the cursor position as shown in FIG. 13. FIG. 13 shows an embodiment of the user interface 40 in which, when the user positions the cursor 262 over an asset 263 in the search results section 234 or clicks the right mouse button when the cursor is over an asset in the search results section 234, a popup menu/toolbar 264 is displayed. The toolbar 264 can include various options such as copy, delete, or display associated keywords.

FIG. 14 shows an alternative embodiment of the find similar function for the visual catalog system 10. In this embodiment, a search results window 270 is generated using a combination of search keywords entered by the user. The “Top level” tab 271 indicates that this is the top level with the search results from the user's keyword input. The user then selected two assets 272 and 274 in the search results window 270 and selected the find similar function using a popup menu, pull down menu, keyboard command or other function selection device. The visual catalog system 10 then uses the keywords associated with the assets 272 and 274, to find other assets that have similar keyword associations, and the results are displayed in a first similar window 280. The first similar window 280 can be accessed using the “Similar 1” tab 281. The first similar window 280 displays a reference image set 282 and shows the images found in this first find similar search. The user can continue to use the find similar functionality to find assets similar to those displayed in the first similar window 280. In the example shown, the user then selected three assets 284, 285 and 286 in the similar window 280 and selected the find similar function. The visual catalog system 10 used the keywords associated with the assets 284, 285 and 286, to find other assets that have similar keyword associations, and the results are displayed in a second similar window 290. The second similar window 290 can be accessed using a “Similar 2” tab 291. The second similar window 290 displays a reference image set 292 and shows the images selected for this second find similar search. The windows 270, 280 and 290 can be overlaid in a single window and the tabs 271, 281 and 291 can be used to switch between the windows 270, 280 and 290. The same functionality described above for assets displayed in the search results section of a window can be made available for the assets shown in the windows 270, 280 and 290.

FIG. 14, as well as several other figures, also show that some embodiments of the system can have a “tabbed” interface. FIG. 14 shows three tabs: the “Top level” tab 271 associated with the search results window 270, the “Similar 1” tab 281 associated with the first similar window 280, and the “Similar 2” tab 291 associated with the second similar window 290. A tabbed interface can be used to overlay multiple windows on the same portion of the screen while still enabling the user to bring any desired window 270, 280, 290 to the top using the associated tab 271, 281, 291. FIG. 14 shows three different shots of the screen portion with the different tabs selected.

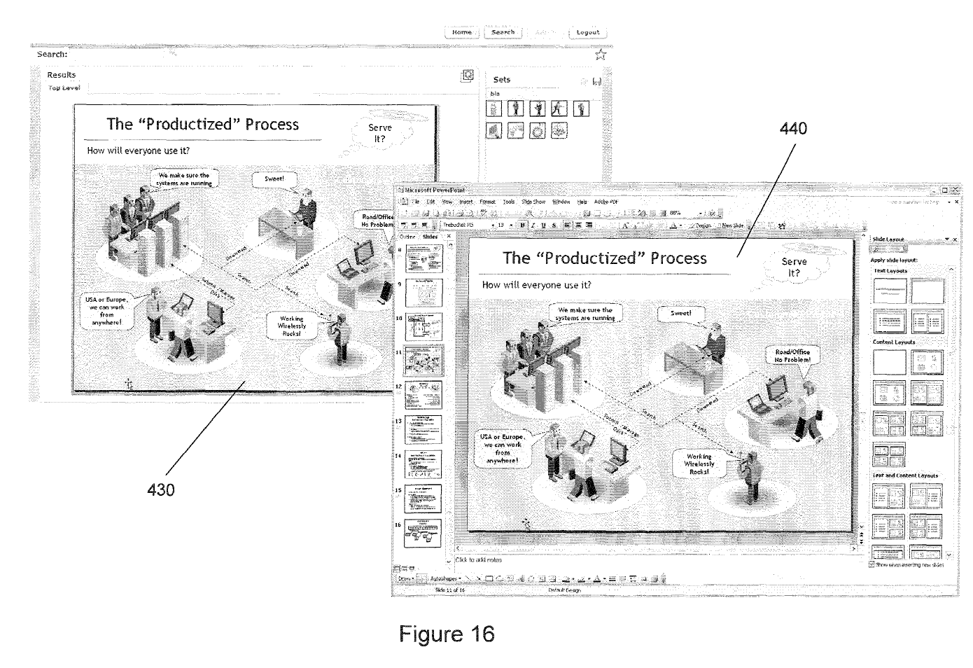

FIG. 15 shows an example of a free form layout interface for preparing content of the visual catalog system 10 for publication or other uses. In this embodiment, a layout window 430 is used to organize content. The “bla” image set 238 discussed with regard to FIG. 12 is used to provide content for the layout window 430. The assets in the “bla” image set 238 are displayed in the image set section 236. The user has selected a laptop asset 432 depicting a man with a laptop from the “bla” image set 238 and placed it in the layout window 430 as shown at position 433. The user has also selected a desk asset 434 depicting a desk from the “bla” image set 238 and placed it in the layout window 430 as shown at position 435. The assets used in the layout window 430 can come from multiple image sets and from assets that are not part of an image set. Like the image sets, the layout window 430 can be controlled by a single user or shared by multiple users collaborating to create the desired layout. FIG. 16 shows an example of exporting the layout window 430 from the visual catalog system 10 and to another application. In this example, the layout window 430 is exported into a Microsoft PowerPoint slide 440.

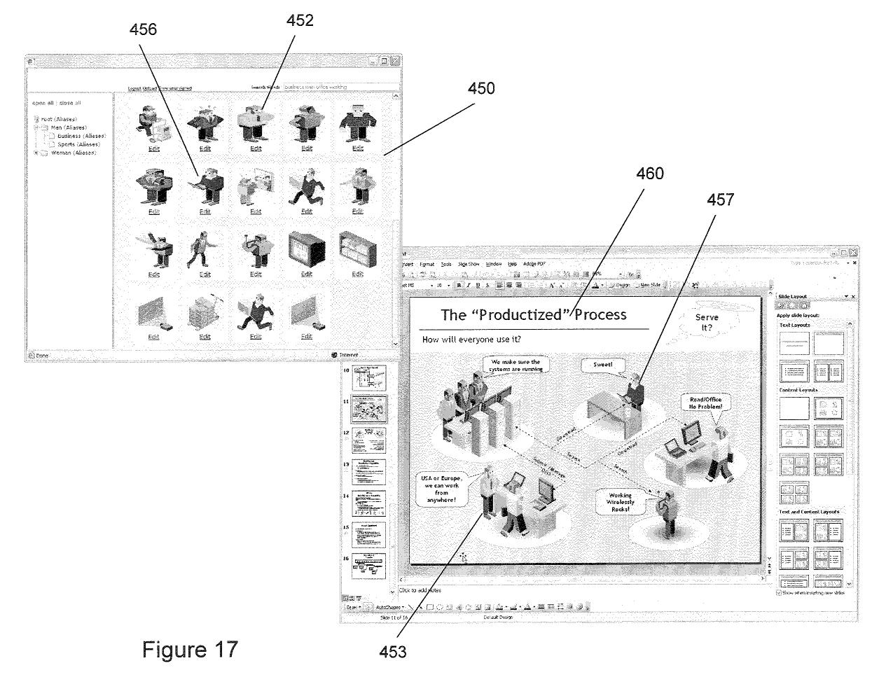

FIG. 17 shows an example embodiment of exporting the content from the visual catalog system 10 to another application. In this embodiment, the content is directly exported from a search results window 450 into a Microsoft PowerPoint slide 460. The user has selected a red tie asset 452 depicting a man wearing a red tie from the search results window 450 and placed it in the slide window 460 as shown at position 453. The user has also selected a laptop asset 456 depicting a man with a laptop from the search results window 450 and placed it in the slide window 460 as shown at position 457. The assets used in the slide window 460 can come from windows in the visual catalog system 10.

The present invention has been illustrated and described with reference to certain exemplary embodiments, variations, and applications. The same is to be considered illustrative and not restrictive in character, it being understood that only some exemplary embodiments have been shown and described and that all changes and modifications that come within the spirit of the invention are desired to be protected. The present invention is defined by the appended claims and therefore should not be limited by the described embodiments, variations, and applications.

I claim:

1. A virtual catalog system for collecting, classifying, storing and exploiting a plurality of assets, the virtual catalog system comprising:
a keyword tree comprising a plurality of nodes, each of the plurality of nodes including at least one keyword;
an administration interface comprising an asset upload section for uploading a new asset to be added to the plurality of assets, and an asset classification section for associating a keyword set with a classified asset, the keyword set including one or more keywords, each of the classified assets being one of the plurality of assets;
a user interface comprising a search field for accepting a search request including one or more keywords, a results tree having at least one branch for displaying the keywords included in the search request, and a displayed results set, the displayed results set being a subset of the plurality of assets; and
a search engine configured to search the plurality of assets based on the keywords of the search request and return a search results set, the search results set being a subset of the plurality of assets wherein each asset of the search results set is associated with all of the keywords included in the search request, the search results set being displayed as the displayed results set in the user interface after a search is initially performed.

2. The virtual catalog system of claim 1 further comprising a login window, the login window comprising a login field, a password field and a corporate ID field, wherein the virtual catalog system prevents access until a valid set of entries is entered in the login field, the password field and the corporate ID field; and the virtual catalog system determines the access privileges of the user based on the entry in the corporate ID field.

3. The virtual catalog system of claim 1 wherein the asset upload section of the administration interface further comprises a batch option for uploading a plurality of new assets simultaneously.

4. The virtual catalog system of claim 1 wherein the keyword set is associated with the classified asset by selecting an associated node of the keyword tree, the associated node being one of the plurality of nodes, such that when the associated node is selected all of the keywords of the associated node are associated with the classified asset.

5. The virtual catalog system of claim 4 wherein when the associated node of the keyword tree is associated with the classified asset, all of the keywords of all of the ancestor nodes of the associated node are also associated with the classified asset.

6. The virtual catalog system of claim 5 wherein the administration interface further includes a keyword entry field, wherein an administrator entered keyword can be added to the keywords associated with the classified asset using the keyword entry field.

7. The virtual catalog system of claim 5 wherein the administration interface further includes a keywords association section, wherein a selected keyword of the keywords associated with the classified asset can be deleted from the keywords associated with the classified asset using the keywords association section.

8. The virtual catalog system of claim 5 wherein the administration interface further includes an unassigned selection, wherein the unassigned selection displays the plurality of assets that are not one of the classified assets.

9. The virtual catalog system of claim 5 wherein the administration interface further comprises a capability to associate asset attributes with the classified asset, and the user interface further comprises a results attribute section.

10. The virtual catalog system of claim 9 wherein the asset attributes are associated with the classified asset automatically.

11. The virtual catalog system of claim 9 wherein the results attribute section includes a file type attribute field that identifies the file type of a selected asset, the selected asset being one of the displayed results set.

12. The virtual catalog system of claim 1 wherein the branches of the results tree are selectable, and the displayed results set of the user interface are varied based on a selected branch of the results tree, wherein when the selected branch is selected each asset of the displayed results set is associated with all of the keywords included in the selected branch of the results tree.

13. The virtual catalog system of claim 1 wherein the order of the displayed results set is determined based on the correspondence of the keywords associated with each of the assets of the displayed results set with the keywords of the selected branch of the results tree.

14. The virtual catalog system of claim 1 further comprising an image set, the image set comprising one or more assets selected from the displayed results sets of the user interface.

15. The virtual catalog system of claim 14 wherein the image set is accessible by a plurality of users using the virtual catalog system.

16. The virtual catalog system of claim 14 further comprising a layout interface, wherein an asset from the image set can be positioned at a user selectable location in the layout interface.

17. The virtual catalog system of claim 1 further comprising a layout interface, wherein an asset from the displayed reults set can be positioned at a user selectable location in the layout interface.

18. The virtual catalog system of claim 1 further comprising a find similar function configured to search for assets based on a reference set of assets selected from the displayed results set.

19. The virtual catalog system of claim 1 wherein each keyword of the keyword set associated with a classified asset is assigned an importance level indicating the relevance of that keyword to the classified asset.

20. A method of collecting, classifying, storing and exploiting a plurality of assets, the method comprising:
creating a keyword tree comprising a plurality of nodes, each of the plurality of nodes including at least one keyword;
collecting the plurality of assets;
classifying assets by associating a keyword set with each classified asset, the keyword set including one or more keywords, each classified asset being one of the plurality of assets;
accepting a search request, the search request comprising one or more keywords;
searching the plurality of assets based on the keywords included in the search request;
creating a results tree having a branch for each keyword included in the search request;
displaying a displayed results set, the displayed results set being a subset of the plurality of assets wherein each asset of the displayed results set is associated with all of the keywords included in the search request.

21. The method of claim 20, wherein, when the search request is blank, the displayed results set includes all of the assets of the plurality of assets.

22. The method of claim 20, wherein the searching step comprises:
for each keyword in the search request, forming a keyword specific asset set including every classified asset that has that keyword associated with it; and
for each keyword group in the search request, forming a keyword group specific asset set including the intersection of the keyword specific asset sets for each keyword included in the keyword group.

23. The method of claim 22, wherein the creating a results tree step comprises:
having a keyword group branch for any keyword group in the search request; and
having a set of child branches from the keyword group branch, the set of child branches including a child branch for each keyword included in the keyword group, and a child branch for any keyword subgroup included in the keyword group.

24. The method of claim 23, wherein each branch of the results tree includes a number indicating the number of classified assets contained in the keyword specific asset set or the keyword group specific asset set for that branch.

25. The method of claim 20, further comprising automatically associating attributes to the classified asset.

26. The method of claim 25, wherein the automatically associated attributes include at least one of asset size, asset type, asset color concentration, and asset orientation.

27. The method of claim 20, wherein the classifying assets step further comprises:
selecting a node of the keyword tree to associate all of the keywords of the selected node and all of the ancestor nodes of the selected node with the classified asset.

28. The method of claim 20, further comprising:
enabling a user to select a branch of the results tree;
when a branch of the results tree is selected, updating the displayed results set to include only those assets having all of the keywords of the selected branch of the results tree in the keyword set associated with the classified asset.

29. The method of claim 20, wherein the classifying assets step further comprises:
associating a level of importance with each keyword in the keyword set associated with the classified asset.

30. The method of claim 29, wherein the associating a level of importance step comprises:
separating the keywords in the keyword set into primary keywords, secondary keywords and tertiary keywords, the primary keywords being more relevant to the classified asset than the secondary keywords, and the secondary keywords being more relevant to the classified asset than the tertiary keywords.

31. The method of claim 29, further comprising:
determining an importance level of each asset in the displayed results set based on the importance of the keywords from the search request with that asset in the keyword set associated with the classified asset,
ordering the assets of the displayed results set based on the importance level of each asset in the displayed results set,
displaying the displayed results set in order of importance.

32. The method of claim 20, further comprising spell-checking the words in the search request.

33. The method of claim 20, further comprising providing a thesaurus function to suggest alternative words for the search request.

34. The method of claim 33, wherein the alternative words are based on the keywords included in the keyword tree.

35. The method of claim 20, further comprising:
associating asset attribute values with each classified asset;
displaying asset attribute values for a selected asset of the displayed results set.

36. The method of claim 35, wherein the selected asset can represent an asset that is available in multiple versions, each version having different asset attribute values, and selecting the selected asset causes the asset attribute values for all versions of the selected asset to be displayed.

37. The method of claim 20, further comprising:
associating asset attribute values with each classified asset;
displaying a selection of asset attribute values;
enabling the user to select a set of attribute values from the selection of asset attribute values;
filtering the displayed results set to display only those assets having the selected set of attribute values.

38. The method of claim 20, further comprising:
enabling a user to create an image set including one or more assets from the displayed results set;
enabling multiple users to share acces to the image set to add, delete and reorder images in the image set.

39. The method of claim 20, further comprising:
enabling a user to position one or more assets in a layout interface; and
enabling a user to export the layout interface to another computer application.

40. The method of claim 20, further comprising a find similar function configured to search for classified assets based on a reference set of assets selected from the displayed results set.

41. The method of claim 40, wherein the find similar function comprises the steps of:
accepting a user-selected group of one or more assets from the displayed asset set;
creating a similar search request with the keywords from the keyword sets associated with the user-selected group;
searching the plurality of assets based on the keywords included in the similar search request;
displaying a similar results set, the similar results set being a subset of the plurality of assets wherein each asset of the similar results set is associated with all of the keywords included in the similar search request.
